(19) United States
(12) Patent Application Publication
(10) Pub. No.: US 2024/0064868 A1
(43) Pub. Date: Feb. 22, 2024

(54) HIGH POWER PPTC HEATER FOR LOW LIMITING TEMPERATURE OPERATION

(71) Applicant: Dongguan Littelfuse Electronics Company Limited, Dongguan City (CN)

(72) Inventors: Jianhua CHEN, Sunnyvale, CA (US); Zhiyong ZHOU, Dongguan City (CN); Yingsong FU, Dongguan City (CN)

(73) Assignee: Dongguan Littelfuse Electronics Company Limited, Dongguan City, GU (CN)

(21) Appl. No.: 18/269,630

(22) PCT Filed: Dec. 28, 2020
(86) PCT No.: PCT/CN2020/140264

§ 371 Date: Jun. 26, 2023

(51) Int. Cl. H05B 3/14; H05B 3/03; H01M 10/6571

(52) U.S. Cl. CPC H05B 3/146; H05B 3/03; H01M 10/6571; H05B 2203/02

(57) ABSTRACT

A resistance heater may include a polymer positive temperature coefficient (PPTC) material, arranged in a PPTC body defining a heater main surface. The PPTC material may include a polymer matrix, the polymer matrix defining the PPTC body, and a graphene filler component, disposed in the polymer matrix. The resistance heater may include an electrode assembly, comprising a first electrode and a second electrode arranged in contact with the heater body at two or more locations, a first lead, connected to the first electrode, and a second lead, connected to the second electrode. As such, the electrode assembly may define a current path between the first lead and the second lead, the current path comprising a first portion, extending along the heater main surface, and a second portion, extending through the heater body.

### BACKGROUND

### Field

Embodiments relate to the field of resistance heaters, and more particularly to heaters based upon PPTC materials.

### Discussion of Related Art

Automobiles and other apparatus may include components that are designed to operate over a wide temperature range. Examples of components that may operate over a wide temperature range include batteries used to power automobiles. In one example, lithium ion (Li-ion) batteries have found application as batteries for electric vehicles, providing high power and high energy density. The performance of Li-ion batteries is adversely affected when automobiles containing the batteries are used in cold climates, especially at sub-zero temperatures. Li-ion batteries having carbonaceous anodes, which batteries are currently the dominant type of vehicular traction batteries, are generally known for their poor performance at such temperatures, caused by reduced conductivity of electrolyte and solid-electrolyte interface (SEI), slow solid-state lithium diffusion, high polarization of graphite anode and increased charge-transfer resistance at the electrolyte-electrode interface. Internal battery resistance increases drastically at extreme conditions below −20° C., which circumstance inevitably leads to a considerable decrease in power sourcing/sinking capabilities. Furthermore, there is a high risk of lithium plating at the surface of the anode when the battery is charged at extremely low temperatures, resulting in significant capacity loss and even internal short circuits once the growing lithium dendrites pierce the battery separator. For electric passenger vehicles (EV), a risk exists when a battery requires charging operations in extreme weather and the battery temperature is below zero. Also, a cold start-up is typically needed after parking EV for a long period in cold weather. In such cases, the performance degradation of Li-ion batteries at low temperatures leads to a significant reduction of the driving range of electric passenger vehicles and brings potential safety hazards as well.

To address this problem, one of a solution is to preheat batteries from extremely low temperatures to a pre-specified temperature before normal operations, especially before fast charging. This process can be realized in various ways, and batteries can restore the performance as soon as their temperature rises above zero. For example lithium-ion batteries normally are set to work in a temperature range of approximately 10° C. to +55° C. Notably, Li-ion batteries also have over-heating and thermal degradation issues. Preventing Li-ion battery temperature from increasing above a higher temperature threshold, such as approximately 60° C. is also important.

With respect to this and other considerations the present disclosure is provided.

### BRIEF SUMMARY

In one embodiment, a resistance heater may include a polymer positive temperature coefficient (PPTC) material, arranged in a PPTC body defining a heater main surface. The PPTC material may include a polymer matrix, the polymer matrix defining the PPTC body, and a graphene filler component, disposed in the polymer matrix. The resistance heater may include an electrode assembly, comprising a first electrode and a second electrode arranged in contact with the heater body at two or more locations, a first lead, connected to the first electrode, and a second lead, connected to the second electrode. As such, the electrode assembly may define a current path between the first lead and the second lead, the current path comprising a first portion, extending along the heater main surface, and a second portion, extending through the heater body.

In another embodiment, a battery is provided including at least one battery cell, and a resistance heater, arranged in thermal contact with the battery. The resistance heater may include a polymer positive temperature coefficient (PPTC) material, arranged in a heater body, wherein the PPTC material comprises: a polymer matrix, the polymer matrix defining the heater body and forming a heater main surface; and a graphene filler component, disposed in the polymer matrix. The battery may include an electrode assembly, comprising two or more electrodes arranged in contact with the heater body at two or more locations, wherein the electrode assembly defines a current path between the first lead and the second lead, the current path comprising a first portion, extending along the heater main surface, and a second portion, extending through the heater body.

In another embodiment a resistance heater may include a polymer positive temperature coefficient (PPTC) material, arranged in a PPTC body defining a heater main surface. The PPTC material may include a polymer matrix, the polymer matrix defining the PPTC body, and a conductive filler component, comprising a graphene filler component, a carbon filler component, or a combination thereof, the conductive filler component disposed in the polymer matrix. The resistance heater may further include an electrode assembly, comprising a first electrode and a second electrode arranged in contact with the heater body on a first side of the heater body as, well as a conductive region, disposed on a second side of the heater body, opposite the first side. The resistance heater may further include a double sided adhesive layer, disposed on the conductive region; a first lead, connected to the first electrode; and a second lead, connected to the second electrode, wherein the electrode assembly defines a current path between the first lead and the second lead, the current path comprising a first portion, extending along the heater main surface, and a second portion, extending through the heater body.

### BRIEF DESCRIPTION OF THE DRAWINGS

FIG. 1A and FIG. 1B depict a top plan view and side cross-sectional view, respectively, of a PPTC heater according to embodiments of the disclosure.

FIG. 2A and FIG. 2B depict a top plan view and side cross-sectional view, respectively, of a PPTC heater according to embodiments of the disclosure.

FIG. 2C presents an equivalent circuit of the embodiment of FIG. 2A;

FIG. 2D presents a side view showing current flow in the embodiment of FIG. 2A;

FIG. 3 and FIG. 4 show additional PPTC heater designs, according to further embodiments of the disclosure.

FIG. 5 and FIG. 6A show additional PPTC heater designs, according to further embodiments of the disclosure.

FIG. 6B presents an equivalent circuit of the embodiment of FIG. 6A;

FIG. 6C presents a side view showing current flow in the embodiment of FIG. 6A;

FIG. 6D presents a side view showing further details of current flow in the embodiment of FIG. 6A;

FIG. 6E show additional details of the PPTC heater design of the embodiment of FIG. 6A;

FIG. 7 shows an additional PPTC heater design, according to further embodiments of the disclosure.

FIG. 8 shows an additional PPTC heater design, according to further embodiments of the disclosure.

FIG. 9 shows an additional PPTC heater design, according to further embodiments of the disclosure.

FIG. 10 and FIG. 11 show a side view of a resistance heater component according to different embodiments of the disclosure.

FIG. 12A shows exemplary resistance data for a PPTC heater arranged according to the present embodiments;

FIG. 12B is a graph illustrating heater power as a function of temperature for a PPTC heater having a heater body arranged according to some embodiments;

FIG. 12C is a graph illustrating heater power as a function of temperature for a PPTC heater arranged according to other embodiments;

FIG. 12D is a graph illustrating heater power as a function of temperature for PPTC heaters having a heater body arranged according to embodiments of the disclosure.

FIG. 13A illustrates an exemplary PPTC heater design; and

FIG. 13B and FIG. 13C illustrate electrical properties of a heater arranged according to FIG. 13A.

### DESCRIPTION OF EMBODIMENTS

The present embodiments will now be described more fully hereinafter with reference to the accompanying drawings, in which exemplary embodiments are shown. The embodiments are not to be construed as limited to the embodiments set forth herein. Rather, these embodiments are provided so that this disclosure will be thorough and complete, and will fully convey their scope to those skilled in the art. In the drawings, like numbers refer to like elements throughout.

In the following description and/or claims, the terms “on,” “overlying,” “disposed on” and “over” may be used in the following description and claims. “On,” “overlying,” “disposed on” and “over” may be used to indicate that two or more elements are in direct physical contact with one another. Also, the term “on,”, “overlying,” “disposed on,” and “over”, may mean that two or more elements are not in direct contact with one another. For example, “over” may mean that one element is above another element while not contacting one another and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In various embodiments, a novel resistance heater based upon polymer positive temperature coefficient (PPTC) material, also referred to herein as a PPTC heater, is provided.

Various embodiments of a PPTC heater provide a high power and low temperature limiting heater useful for heating apparatus, such as Li-ion batteries, such as during relatively cold ambient conditions. According to embodiments of the disclosure, a PPTC heater may be based upon a semiconducting resistive graphene or graphene/carbon based compositive material. Characteristic of such heaters are low weight, low thermal capacity, uniform heating, and quick electro-thermal response time.

In various embodiments a novel battery assembly or battery is provided, including a PPTC heater, placed at the surface of one or more battery cells, to generate heat as needed for warm-up of the battery cells, providing module efficiency with shortening of a heat transfer route and reduced heat loss to the ambient environment. Thus, high heating efficiency, short heating time, and low energy consumption can be achieved.

As detailed below, one characteristic of the present embodiments, is a relatively low cut-off temperature, where the resistance of a PPTC heater increases significantly when its temperature exceeds 60° C. so that the current flowing through the PTC heater can be regulated by itself to prevent battery cells from overheating. Advantageously, a PPTC heater according to the present embodiments, may be excited under a relatively low voltage.

In some embodiments, a film based PPTC heater may be embedded on an aluminum plate, placed adjacent battery cells. Using this configuration, the film-based heaters have great potential for distributing the heat quickly when a battery is cold, and transfer the battery heat to the PPTC heater to reduce the power when the battery is over-heating.

Compared with relatively bulky conventional electric heaters, the small thickness of these film-based heaters enables a reduction of installation space in a battery pack. Additionally, these film-based panel heaters may present better heating performance than traditional heaters under a relatively low voltage excitation.

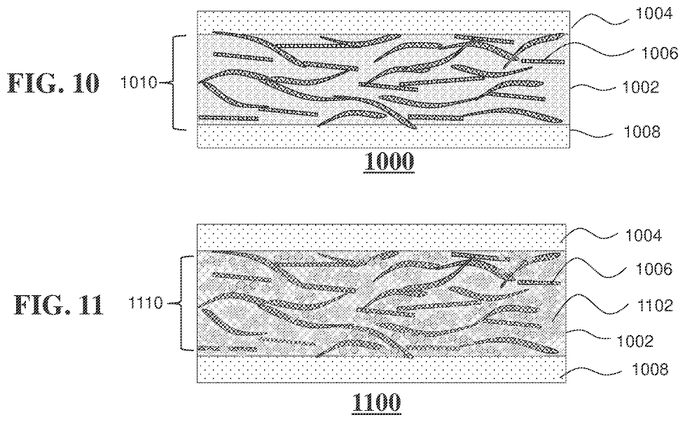

Turning to FIG. 10 and FIG. 11 there are shown a side view of a resistance heater component according to different embodiments of the disclosure. At FIG. 10, a resistance heater component 1000 is shown, having a heater body 1010, as well as opposing electrodes, shown as electrode 1004, and electrode 1008. The heater body 1010 may include a polymer matrix 1002, as well as a graphene filler material 1006. The graphene filler material 1006 may be prepared by a mechanical or a chemical method or electrochemistry method with the graphene layers ranging from 1 to several hundreds within a given graphene particle, an in particular embodiments may include 1˜30 graphene layers. The graphene particle size may range from 0.1 to 100 μm, and in particular embodiments from prefer to 1 to 30 μm. In various embodiments, the graphene volume percent may range from 1-50%, and in particular embodiments from 4-30%.

By way of background, graphene is a crystalline allotrope of carbon with 2-dimensional properties. The carbon atoms are densely packed in a regular atomic-scale hexagonal pattern in graphene. Graphene has high thermal conductivity in the range of 1500-2500 W·m·⁻¹·K⁻¹ In the embodiment of FIG. 10 and FIG. 11, the graphene filler is arranged as sheet-like particles where the particles, meaning the plane of the sheets, is aligned generally along a predetermined plane of the heater body 104, such as along the X-Y plane of the Cartesian coordinate system shown. The high thermal conductivity of the graphene filler material 1006 allows heat transfer to the environment along the Z-direction effectively, as well as uniform heat transfer in the X-Y plane. These thermal properties are particularly useful for heater applications. Additionally, a graphene sheet has a bulk electrical resistivity as low as 10⁻⁶ Ω-cm the most conductive metals have bulk resistivity of close to 2×10⁻⁶ Ω-cm or higher. In addition, the graphene 2D-structure allows a semi-crystalline polymer in the polymer matrix 1002 to contact two sides of a graphene particle so that PPTC material can respond to temperature synchronously when the polymer matrix 1002 reaches a melting point.

Regarding the polymer matrix 1002, suitable polymers include semicrystalline polymers, e.g., polyethylene copolymer (ethylene-vinyl acetate, ethylene and acrylic acid copolymer, ethylene butyl acrylate copolymer, polyolefin elastomer, polyethylene oxide), polyester (polycaprolactone, polyester), polyether (polyethylene glycol, polytetrahydrofuran), polyurethane (polyurethane), polyamide or its copolymer, and diene elastomer and its copolymer where the volume percentage of polymer may range from 50˜99%, and in particular from 60˜95% according to different non-limiting embodiments.

At FIG. 11, a resistance heater component 1100 is shown, having a heater body 1110, as well as opposing electrodes, shown as electrode 1004, and electrode 1008. The heater body 1010 may include a polymer matrix 1002, as well as a graphene filler material 1006, as described with respect to FIG. 10. In addition, the heater body 1110 may include a conductive particle filler 1102, formed from carbon, conductive ceramic, or a combination of the two. In various embodiments, a carbon primary particle size may range from 10˜100 nm with DBP surface area value* of 5-500 (cm³/100 g), and 8 to 200 (cm³/100 g) in particular embodiments (*The DPB measurement is based on ASTM D3493). In some variants of the embodiment of FIG. 11, the carbon particle filler vs. graphene percentage may range from 0%:100% to 100%:0%, and in particular from 20%:80% 80%:20%. More generally, in some non-limiting embodiments of FIGS. 10 and 11, the volume fraction of conductive filler (including graphene and/or carbon) in a PPTC material that is used for a heater may range from 1% to 50%.

While the configurations of FIGS. 10 and 11 illustrate electrodes generally formed on opposing surfaces of a planar or sheet structure for the heater body, in different embodiments one or more electrodes may be located on one or both sides of a heater body, as detailed in the embodiments to follow.

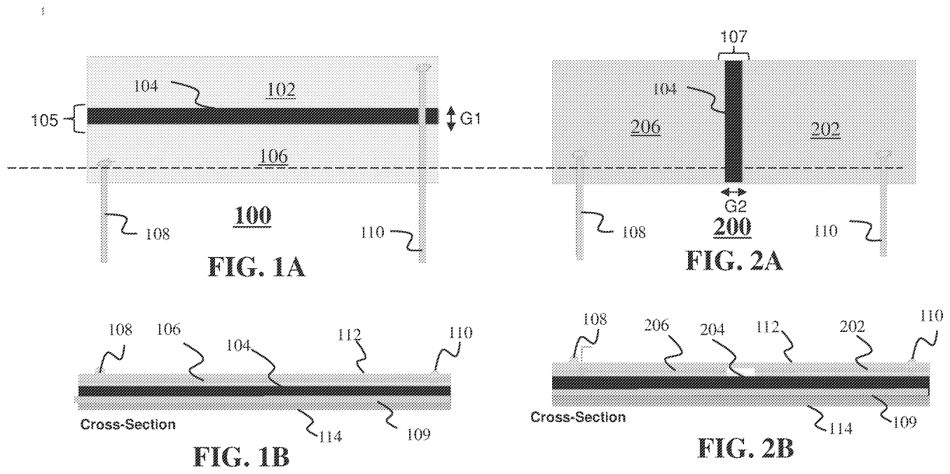

FIG. 1A and FIG. 1B depict a top plan view and side cross-sectional view, respectively, of a PPTC heater according to embodiments of the disclosure. The PPTC heater 100 may include a heater body 104, generally as discussed previously. The PPTC heater 100 includes a first electrode 102 and a second electrode 106, disposed on an upper surface of the heater body 104. These electrodes are separated by a slot 105, where no electrode (or electrode material, meaning, for example, a metal layer) is present, and the heater body 104 may be exposed. An insulation tape 112 may be disposed over the first electrode 102 and second electrode 106 as shown in FIG. 1B. A bottom conductive region 109 and a double sided adhesive layer 114 may be disposed on the lower surface of the heater body 104, to allow the PPTC heater 100 to be applied directly to a surface of an object to be heated, such as a battery cell. In this embodiment and other embodiments to follow, a bottom conductive region, such as the bottom conductive region 109, may be formed of similar material or the same material as the first electrode 102 and second electrode 106 in some embodiments. The bottom conductive region 109 in this embodiment and in some other embodiments to follow is not referred to herein as an electrode, because no direct contact to external wires or external conductors is made to the bottom conductive region 109.

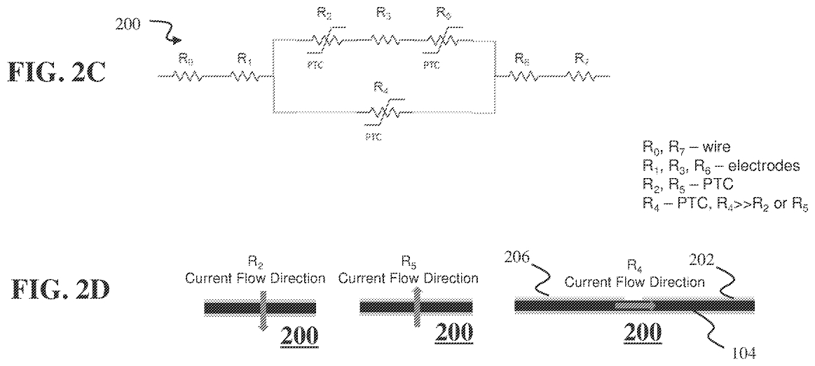

FIG. 2A and FIG. 2B depict a top plan view and side cross-sectional view, respectively, of a PPTC heater according to embodiments of the disclosure. The PPTC heater 200 may include a heater body 104, generally as discussed previously. The PPTC heater 200 includes a first electrode 202 and a second electrode 206, disposed on an upper surface of the heater body 104. These electrodes are separated by a slot 107, where no electrode is present, and the heater body 104 may be exposed. An insulation tape 112 may be disposed over the first electrode 202 and second electrode 206 as shown in FIG. 2B. A bottom conductive region 109 and double sided adhesive layer 114 may be disposed on the lower surface of the heater body 104, to allow the PPTC heater 200 to be applied directly to a surface of an object to be heated, such as a battery cell. In the embodiments of FIGS. 1A-2B, the two electrodes are separated by a gap, so that current traveling between a first lead (wire) 108 and a second lead, wire 110, may be directed to flow through the heater body 104 parallel to the main surface, as shown by R4 in FIG. 2D, for the specific configuration of FIG. 2A.

The design of FIGS. 1A-2B exhibit the same general power designs (where N=1, given N represents the number slots on one side of heater electrodes. To explain operation of this design further, FIG. 2C presents an equivalent circuit of the embodiment of FIG. 2A and FIG. 2B, while FIG. 2D presents a side view showing current flow in the embodiment of FIG. 2A or FIG. 2B. As illustrated in FIG. 2C, R₀, R₇ represent resistance of the wire 108 and wire 110, R₁, R₃, R₆ represent resistance of the electrodes 106 (206), 102 (202), and 108, respectively; R₂ and R₅ represent resistance through the thickness of the heater body 104 of the PPTC; while R4 represents resistance in the heater body 104 along the direction parallel to the main plane of the heater body 104, as illustrated in FIG. 2D. In various embodiments, the design of the heater body and electrodes may be such that the value of R4 is much greater than the value of R2 or R5. This situation may be accomplished by arranging the thickness of the heater body 104 to be relatively less, such as between 3 mils and 100 mils in various non-limiting embodiments, between 5 mils and 10 mils in some embodiments, while the value of the gap, either gap G1 between electrode 102 and electrode 106, or gap G2, between first electrode 202 and second electrode 206, is relatively greater than the thickness of the heater body 104. For example, if the thickness of the heater body 104 is 10 mils, the value of gaps G1 or G2 may be 50 mils or greater, ensuring that R4 is much larger than R2 or R5.

In sum, the resistance of a PPTC heater represented by the equivalent circuit (FIG. 2C) for the embodiments of FIGS. 1A-2B is approximately the value of the initial resistance multiplied by 4 (R≈4Rᵢ when R₂=R₅ and the heater is in a non-tripping state). According to variants of these embodiments, the design of the slot (either slot 105 or slot 107) location can determine the heating effect (one side higher; another side lower, by control the resistance of each PPTC segment) on the top and bottom (FIG. 1) or on the left and right sides (FIG. 2). In addition, the FIG. 1 design has a better mechanical strength in examples where the overall heater is to be bent in an annular shape.

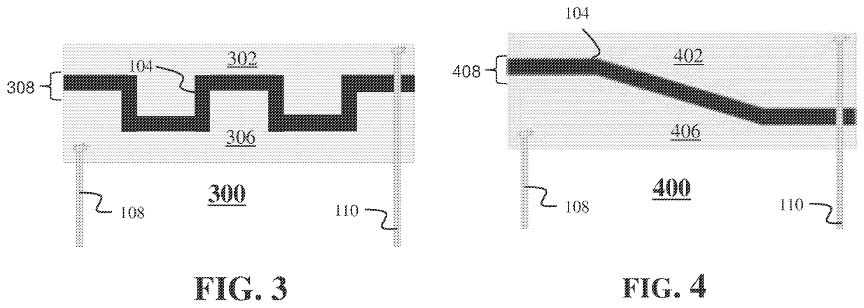

FIG. 3 and FIG. 4 show a PPTC heater 300 and a PPTC heater 400 according to further embodiments of the disclosure, where the shape of a slot is non-linear, meaning the given non-linear slot is not arranged in a straight line. In these configurations, two electrodes, electrode 302 and electrode 306, separated by a serpentine slot 308, or electrode 402 and electrode 406, separated by a staggered slot 408, are provided on a same surface of the heater body 104, and current flow will generally be the same as in FIGS. 1A-2B. Electrical properties in these configurations are also represented by the equivalent circuit of FIG. 2C, described above. In sum, all the configurations of FIGS. 1A-4, and other similar configurations, are useful for applications where the opposite surface (Not shown in FIGS. 3 and 4, but see lower surface in FIG. 1B) as the surface contacted by the wires 108, 110, is to be applied directly to a body to be heated. In other words, having wires 108, 110 arranged on a common sided of the PPTC heaters allows the opposite side to have a planar surface that can be readily affixed to a surface of a body to be heated, such as a battery. Thus, the design will allow full contact to the heating surface for more effective heating.

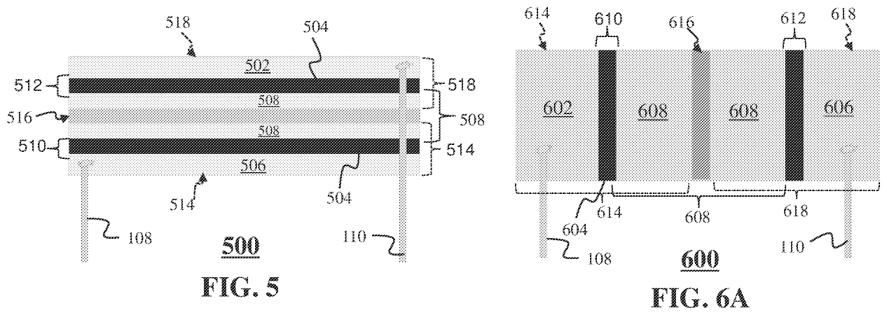

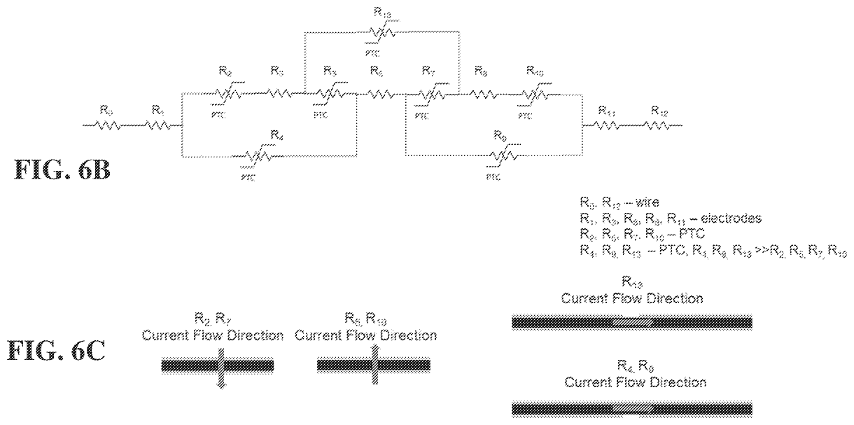

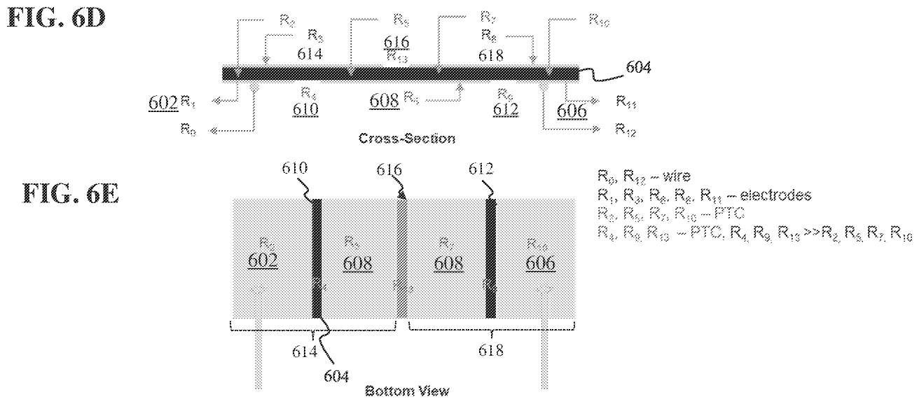

FIG. 5 and FIG. 6A show a PPTC heater 500 and a PPTC heater 600 according to further embodiments of the disclosure. FIG. 6B presents an equivalent circuit of the embodiment of FIG. 6A. FIG. 6C presents a side view showing current flow in the embodiment of FIG. 6A. FIG. 6D presents a side view showing further details of current flow in the embodiment of FIG. 6A. FIG. 6E show additional details of the PPTC heater design of the embodiment of FIG. 6A.

As in the aforementioned embodiments, the design of FIG. 5 and FIG. 6A share the common feature that two electrodes, connected to external wires, are disposed on the same side of a PPTC heater. In FIG. 5 an electrode 506 is connected to wire 108 and an electrode 502 is connected to a wire 110. The electrode 502 is separated from the electrode 506 by a slot 510 and a slot 512, where no conductive layer is present, exposing the heater body 504. In addition, a conductive region 508 is disposed between the slot 512 and slot 510, where a material, such as a material of the electrode 502 and electrode 506 is present. The slots 510, 512 thus define regions along the surface of PPTC heater 500 that are relatively higher resistance, as compared to the resistance of the electrodes 502, 506 and the material of conductive region 508. In the example of FIG. 5, the slots 510, 512 are arranged to extend perpendicularly with respect to the general direction of the wire 108 and the wire 110. In addition to the electrodes 502, 506 and conductive region 508, the PPTC heater 500 includes a pair of bottom conductive regions, shown as conductive region 514 and conductive region 518, disposed on the opposite side of the heater body 504, and separated by a bottom slot, shown as slot 516.

As such, the PPTC heater 500 may be characterized by the equivalent circuit shown in FIG. 6B, where R0 and R12 represent the resistance of the wires 108, 110, R1, R3, R6, R8, R11 represent resistance of the electrodes, R2, R5, R7, and R10 represent the resistance of the heater body 504 to current flowing through the thickness of the heater body 504, and R4, R9, and R13 represent resistance of the heater body 504 to current flowing along the surfaces of heater body 504. In particular, during operation below the trip temperature, the current of the PPTC heater 500 may flow between wire 108 and wire 110 by flowing mainly through wire 110 (R0) through the electrode 506 (R1), through the thickness of the heater body 504 (R2) (see FIG. 6C, left, and also see FIG. 6D); along the surface of conductive region 514 (R3), through the thickness of the heater body 504 (R5) in the opposite direction (see FIG. 6C, middle); along the surface of conductive region 508 (R6);), through the thickness of the heater body 504 (R7) (see FIG. 6C, left); along the surface of conductive region 518 (R8); through the thickness of the heater body 504 (R10) in the opposite direction (see FIG. 6C, middle); through the electrode 502, and wire 110 (R12). Generally, because the size of the slots 516, 510, 512 may be much larger than the thickness of the heater body 504, the current may not flow along the paths in the plane of the heater body as indicated by resistances R4, R9, R13 (see FIG. 6C, right).

In FIG. 6, the heater configuration is generally the same as PPTC heater 500, except that a pair of slots 610, 612 are arranged to extend generally parallel with respect to the general direction of the wire 108 and the wire 110. In particular, an electrode 602 is connected to wire 108 and an electrode 606 is connected to a wire 110. The electrode 602 is separated from the electrode 606 by a slot 612 and a slot 610, where no conductive layer is present, exposing the heater body 604. In addition, a conductive region 608 is disposed between the slot 512 and slot 510, where a material, such as a material of the electrode 602 and electrode 606 is present. The slots 612, 610 thus define regions along the surface of PPTC heater 600 that are relatively higher resistance, as compared to the resistance of the electrodes 602, 606 and the material of conductive region 608. In addition to the electrodes 602, 606 and conductive region 608, the PPTC heater 600 includes a pair of bottom conductive regions, shown as conductive region 614 and conductive region 618, disposed on the opposite side of the heater body 604, and separated by a bottom slot, shown as slot 616.

As such, the PPTC heater 600 may be characterized by the equivalent circuit shown in FIG. 6B, where R0 and R12 represent the resistance of the wires 108, 110, R1, R3, R6, R8, R11 represent resistance of the electrodes, R2, R5, R7, and R10 represent the resistance of the heater body 604 to current flowing through the thickness of the heater body 604, and R4, R9, and R13 represent resistance of the heater body 604 to current flowing along the surfaces of heater body 604. In particular, during operation below the trip temperature, the current of the PPTC heater 600 may flow between wire 108 and wire 110 by flowing mainly through wire 110 (R0) through the electrode 602 (R1), through the thickness of the heater body 604 (R2) (see FIG. 6C, left, and also see FIG. 6D); along the surface of conductive region 614 (R3), through the thickness of the heater body 604 (R5) in the opposite direction (see FIG. 6C, middle); along the surface of conductive region 608 (R6);), through the thickness of the heater body 604 (R7) (see FIG. 6C, left); along the surface of conductive region 618 (R8); through the thickness of the heater body 604 (R10) in the opposite direction (see FIG. 6C, middle); through the electrode 606, and wire 110 (R12). Generally, because the size of the slots 616, 610, 612 may be much larger than the thickness of the heater body 604, the current may not flow along the paths in the plane of the heater body as indicated by resistances R4, R9, R13 (see FIG. 6C, right).

In summary, the PPTC heater configurations of FIG. 5 and FIG. 6 provide the same power designs (N=3). The resistance of the given heater resistance is approximately the initial resistance multiplied by 16 (R≈16Rᵢ when R₂=R₅=R₇=R₁₀ and heater in a non-tripped state).

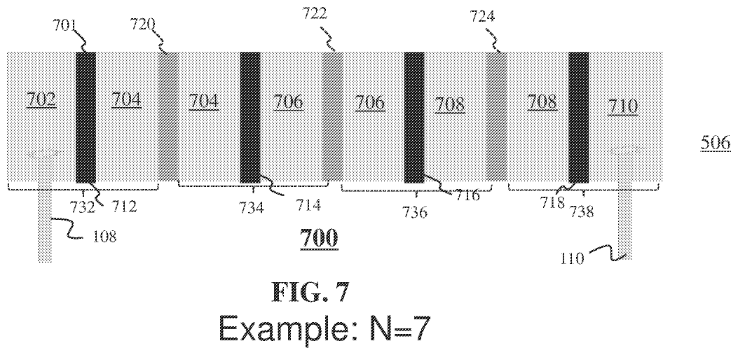

Of course, other configurations for PPTC heaters of the present embodiments may include electrode designs separated by additional slots. FIG. 7 shows an additional PPTC heater design, according to further embodiments of the disclosure. The PPTC heater 700 includes a heater body 701, made of PPTC material, as described previously. In this example, the general configuration is similar to the PPTC heater 600, except more slots are provided on each side of the heater body 701.

A total of N slots are shown, where N=7 in the specific illustration. While no equivalent circuit is shown, derivation of such a circuit will easily show that the resistance may be approximately equal to (N+1)²=64Rᵢ when all PPTC segments have the same resistance and the PPTC heater 700 is in a non-tripped state. The PPTC heater 700 includes an electrode 702, slot 712, conductive region 704, slot 714, conductive region 706, slot 716, conductive region 708, slot 718, and electrode 710, all on a first side of the heater body 701, where the wires 108, 110 are disposed. In addition, the PPTC heater 700 includes conductive region 732, slot 720, conductive region 734, slot 722, conductive region 736, slot 724, and conductive region 738, all the opposite side of the heater body 701, with respect to the wires 108, 110. As such, electrical current path will pass through the thickness of the heater body 701 many times, as determined by the number of slots, for the reasons as generally described with respect to the aforementioned embodiments.

For additional embodiments of the disclosure, the number of the slots on one of the heater electrodes may be designed to meet different power requirements from a fixed resistivity PPTC material. The slot locations in a heater electrode may also be designed to achieve different desired heating effects.

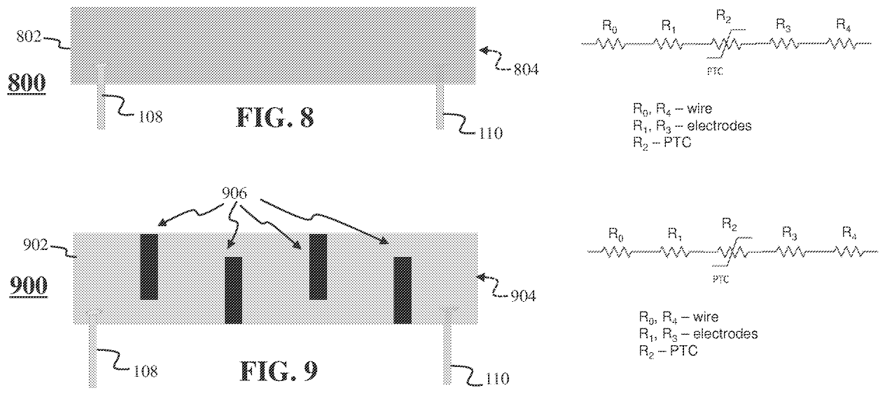

FIG. 8 shows an additional PPTC heater design, according to further embodiments of the disclosure. The PPTC heater 800 may include a heater body (not visible in the figure) as generally described above, sandwiched between a top electrode 802 and a bottom electrode 804. In this example, the top electrode 802 is connected to wire 108, while the bottom electrode 804 is connected to wire 110. As such, current will pass through the thickness of the PPTC heater body, with the equivalent circuit shown to the right.

FIG. 9 shows an additional PPTC heater design, according to further embodiments of the disclosure. The PPTC heater 900 may include a heater body (not visible in the figure) as generally described above, sandwiched between a top electrode 902 and a bottom electrode 904. In this example, the top electrode 902 is connected to wire 108, while the bottom electrode 904 is connected to wire 110. As such, current will pass through the thickness of the PPTC heater body, with the equivalent circuit shown to the right. In addition, the PPTC heater 900 may include multiple staggered slots, shown as slots 906, where the slots 906 have the effect of defining a serpentine current path, by defining a serpentine pattern to the top electrode 902.

Note that while not explicitly shown, the embodiments of FIGS. 3-9 may also include a top and side insulator layer and bottom adhesive layer as in FIG. 1B.

In sum, the aforementioned designs of FIGS. 1A-9 and especially for FIGS. 1A-7 provide a flexible approach for heating surfaces, such as batteries, where a thin PTC heater may be applied conveniently to any suitable surface.

### EXAMPLES

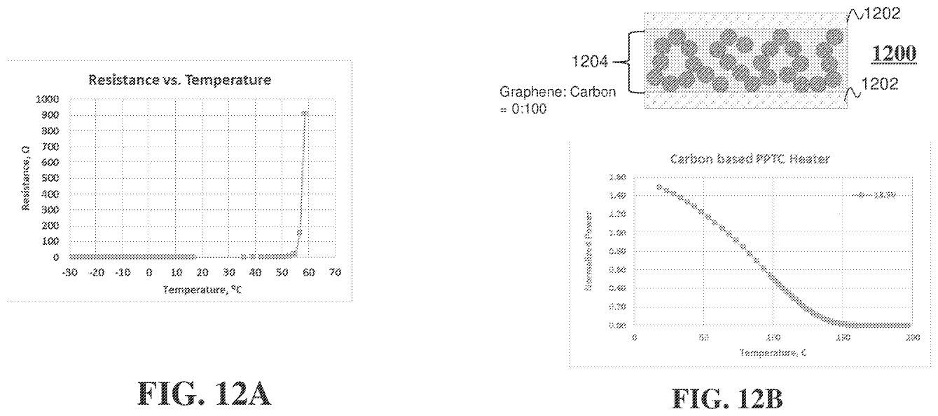

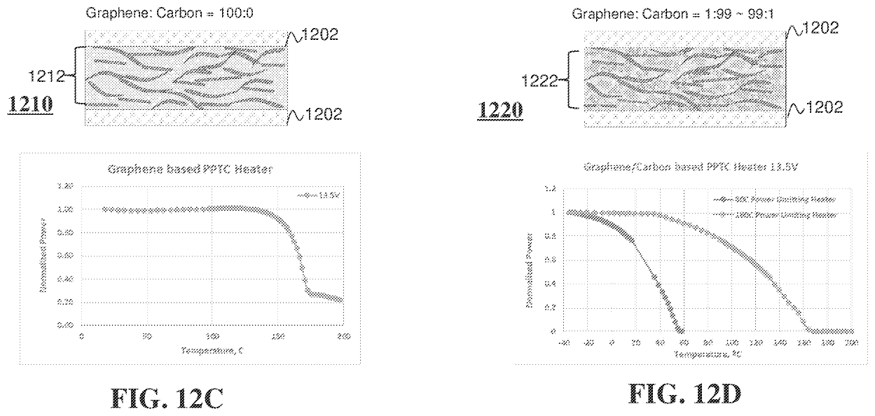

FIG. 12A shows exemplary resistance data for a PPTC heater arranged according to the present embodiments, based upon a polycaprolactone polymer filled with graphene and carbon. temperature of the heater. As shown, the resistance remains low below a tripping temperature of ˜55 C, above which temperature the resistance increases by several orders of magnitude. As such, the PPTC heater will limit current and therefore heating when temperature exceeds approximately 55 C.

In order to tailor the heater power response according to a desired application, the composition of the conductive filler in a PPTC heater body may be adjusted. FIG. 12B is a graph illustrating heater power as a function of temperature for a PPTC heater 1200 having a heater body 1204 made of polyvinylidene fluoride (PVDF) polymer matrix, having 0% graphene filler and 100% carbon filler, disposed between two planar electrodes, shown as electrodes 1202. The two curves are shown for two different voltages applied across the heater body 1212. As shown, the power decreases steadily from room temperature to 150 C, reaching a value close to zero at 150 C.

FIG. 12C is a graph illustrating heater power as a function of temperature for a PPTC heater 1210 having a heater body 1212 made of PVDF polymer matrix, having 100% graphene filler and 0% carbon filler, disposed between two planar electrodes, shown as electrodes 102. The two curves are shown for two different voltages applied across the heater body 1222. As shown, the power level remains steady from room temperature up to 140° C., with a rapid decrease above 150° C., reaching a low, but finite value at approximately 170° C., approximately 20% of room temperature power.

FIG. 12D is a graph illustrating heater power as a function of temperature for PPTC heaters 1220 having a heater body 1222 made of polymer matrix, having mixed graphene filler and carbon filler, disposed between two planar electrodes, shown as electrodes 102. The two curves are shown for two different voltages applied across the heater body 1222. The curves are representative of compositions in the range of 99% graphene/1% carbon to 1% graphene/99% carbon. As shown, for the higher temperature curve (based upon a PVDF polymer matrix), the power level decreases steadily from room temperature up to 165° C., reaching a negligible value at approximately 165° C. As shown, for the lower temperature curve (based upon a polyester polymer matrix, specifically polycaprolactone), the power level decreases steadily from room temperature up to 58° C., with a, reaching a negligible value at approximately 60° C. The above results of FIGS. 12B-12D illustrate that the temperature dependence of heater power may be tailored for a given application by varying the graphene/carbon ratio of the conductive filler, from a relatively constant power to a decreasing power as a function of increasing temperature.

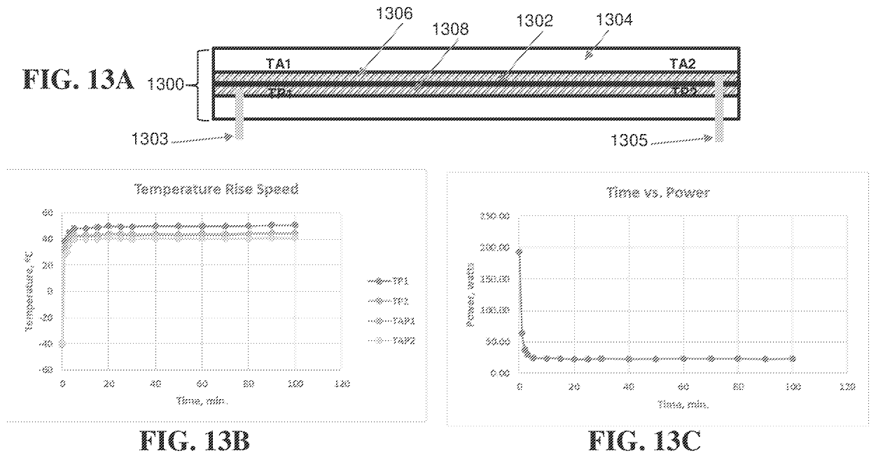

FIG. 13A shows a top plan view of a heater 1300, having a PPTC body 1302, disposed on an aluminum plate 1304. TP1 & TP2 are temperature measurement locations on the heater; and TA1 & TA2 are temperature measurement locations on the aluminum plate 1304. In one example, 12V are applied across the heater 1300, with an aluminum plate volume of 39 cm³ and a heater area of 65 cm². External leads 1303, 1305 are connected to electrodes 1306 and 1308, so that current may flow between the external leads generally as described with respect to FIG. 1A.

FIG. 13B shows heating time vs. temperature for an embodiment of the heater 1300 based upon polyester matrix (polycaprolactone) with carbon/graphene fillers. The different curves are for the different measurement locations, described above. As shown, in less than 5 minutes, the heater 1300 brings the aluminum of a heating object from −40° C. to higher than 40° C., where the temperature plateaus at approximately 40° C. to 50° C., depending upon the exact location in the heater 1300.

FIG. 13C shows the power change with time for the heater 1300 of FIG. 13B. Again, at time zero, the heater is at −40° C. As shown in FIG. 13C, at cold temperature the initial power may be as high as 180 watts. As the heating object temperature goes up in the initial five minutes or so (see FIG. 13B) the power drops to a much lower value and reaches a self-adjusting lower power state at approximately 20 watts, while the temperature remains relatively constant with time.

While the present embodiments have been disclosed with reference to certain embodiments, numerous modifications, alterations and changes to the described embodiments are possible while not departing from the sphere and scope of the present disclosure, as defined in the appended claims. Accordingly, the present embodiments are not to be limited to the described embodiments, and may have the full scope defined by the language of the following claims, and equivalents thereof.

1. A resistance heater, comprising:
a polymer positive temperature coefficient (PPTC) material, arranged in a heater body, defining a heater main surface, wherein the PPTC material comprises:
a polymer matrix, the polymer matrix defining the PPTC body; and
a graphene filler component, disposed in the polymer matrix;
an electrode assembly, comprising a first electrode and a second electrode arranged in contact with the heater body at two or more locations;
a first lead, connected to the first electrode; and
a second lead, connected to the second electrode,
wherein the electrode assembly defines a current path between the first lead and the second lead, the current path comprising a first portion, extending along the heater main surface, and a second portion, extending through the heater body.

2. The resistance heater of claim 1, wherein a volume percentage of polymer matrix is between 50˜99%, wherein a volume fraction of conductive filler is between 1% and 50%.

3. The resistance heater of claim 1, further comprising a carbon filler component, wherein a volume fraction of carbon filler with respect to graphene filler component ranges between 1% and 99%.

4. The resistance heater of claim 1, the first electrode being disposed on a first side of the heater body, and the second electrode being disposed on a second side of the heater body, opposite the first side.

5. The resistance heater of claim 1, the first electrode and the second electrode being disposed on a first side of the heater body.

6. The resistance heater of claim 5, wherein the first electrode and the second electrode are separated from one another by one or more slots, disposed along the first side, the one or more slots comprising regions where no electrode material is present.

7. The resistance heater of claim 6, wherein at least one of the one or more slots is a non-linear slot.

8. The resistance heater of claim 6, further comprising at least one conductive region, disposed along a second side of the heater body, opposite the first side.

9. The resistance heater of claim 8, wherein the at least one conductive region comprises a plurality of bottom conductive regions, separated from one another by one or more bottom slots, disposed along the second side, the one or more bottom slots comprising regions where no electrode material is present.

10. The resistance heater of claim 1, the polymer matrix comprising a polyethylene copolymer a polycaprolactone, a polyether, a polyurethane, a polyamide, a diene elastomer, or combination thereof.

11. A battery, comprising:
at least one battery cell; and
resistance heater, arranged in thermal contact with the battery, the resistance heater comprising:
a polymer positive temperature coefficient (PPTC) material, arranged in a heater body wherein the PPTC material comprises:
a polymer matrix, the polymer matrix defining the heater body, and forming a heater main surface; and
a graphene filler component, disposed in the polymer matrix; and
an electrode assembly, comprising two or more electrodes arranged in contact with the heater body at two or more locations,
wherein the electrode assembly defines a current path between a first electrode and a second electrode, the current path comprising a first portion, extending along the heater main surface, and a second portion, extending through the heater body.

12. The battery of claim 11, wherein a volume percentage of polymer matrix is between 50˜99%.

13. The battery of claim 11, further comprising a carbon filler component, wherein a volume fraction of carbon filler with respect to graphene filler component ranges between 1% and 99% wherein a volume fraction of conductive filler is between 1% and 50%.

14. The battery of claim 11, the first electrode being disposed on a first side of the heater body, and the second electrode being disposed on a second side of the heater body, opposite the first side.

15. The battery of claim 11, the first electrode and the second electrode being disposed on a first side of the heater body.

16. The battery of claim 15, wherein the first electrode and the second electrode are separated from one another by one or more slots, disposed along the first side, the one or more slots comprising regions where no electrode material is present.

17. The battery of claim 16, further comprising at least one conductive region, disposed along a second side of the heater body, opposite the first side.

18. The battery of claim 17, wherein the at least one conductive region comprises a plurality of bottom conductive regions, separated from one another by one or more bottom slots, disposed along the second side, the one or more bottom slots comprising portions of the heater body where no electrode material is present.

19. A resistance heater, comprising:
a polymer positive temperature coefficient (PPTC) material, arranged in a heater body, defining a heater main surface, wherein the PPTC material comprises:
a polymer matrix, the polymer matrix defining the PPTC body; and
a conductive filler component, comprising graphene, carbon, or a combination thereof, the conductive filler component disposed in the polymer matrix;
an electrode assembly, comprising a first electrode and a second electrode arranged in contact with the heater body on a first side of the heater body;
a conductive region, disposed on a second side of the heater body, opposite the first side;
a double sided adhesive layer, disposed on the conductive region;
a first lead, connected to the first electrode; and
a second lead, connected to the second electrode,
wherein the electrode assembly defines a current path between the first lead and the second lead, the current path comprising a first portion, extending along the heater main surface, and a second portion, extending through the heater body.

20. The resistance heater of claim 19, further, comprising: an insulation tape, disposed over the first electrode and the second electrode.
